(19) United States
(12) Patent Application Publication
(10) Pub. No.: US 2016/0232524 A1
(43) Pub. Date: Aug. 11, 2016

(54) Systems and Methods for Managing Transactions to Group Accounts

(71) Applicant: MASTERCARD INTERNATIONAL INCORPORATED, Purchase, NY (US)

(72) Inventors: Robert Shawn Barrale, St. Louis, MO (US); John Patrick Goodwin, Cincinnati, OH (US); Jean Higgins, Dublin (IE); Marlowe Felipe Valdeabella, Ballwin, MO (US); Kate Andrea Fischer, St. Peters, MO (US); Elaine Keating, Dublin (IE); Jeremiah-Richard Tim Bright, St. Charles, MO (US); Carolyn Ann Esposito, New York, NY (US); Susanne Manning, Dublin (IE); Tammy Lynn Hawkins, St. Charles, MO (US); Robert Campion, Clavinstown (IE); Joseph Walter Parker, Ballwin, MO (US); Michael Anthony Cronin, Dublin (IE)

(21) Appl. No.: 14/619,831

(22) Filed: Feb. 11, 2015

(51) Int. Cl. G06Q 20/40; G06Q 30/02

(52) U.S. Cl. CPC G06Q 20/401; G06Q 30/0231

(57) ABSTRACT

Systems and methods for managing payment network transactions to a group account associated with a group are disclosed. One example system includes a memory including a data structure. The data structure includes transaction data representing multiple payment network transactions to the group account. Each of the multiple transactions is identified, in the transaction data, to one of multiple members of the group. The system includes a processor coupled to the memory and configured to cause a member interface to be displayed at a computing device associated with a first member of the group. The member interface includes a first indicator associated with the first member and representative of transactions identified to the first member, and the member interface includes a second indicator associated with a second member of the group and representative of one or more transactions identified to the second member.

### FIELD

The present disclosure generally relates to systems and methods for managing transactions to group accounts of organizations, facilitated by member merchants of the organizations.

### BACKGROUND

This section provides background information related to the present disclosure which is not necessarily prior art.

Members of organizations often participate in fundraisers to raise money to support the organizations. The members may sell products, i.e., goods and/or services, to the public with the proceeds of the sales going to the organizations. Payments associated with fundraising often involve cash, or personal checks, which are received by the members of the organizations, prior to or at the time of delivery of the products. Separately, merchants are known to accept electronic payment for products, whereby customers are able to use payment accounts to complete the purchases of the products. The payment accounts are provided by issuers, which often provide websites, through which the customers are able to view payment account details, including account information and transaction details, etc.

### DRAWINGS

The drawings described herein are for illustrative purposes only of selected embodiments and not all possible implementations, and are not intended to limit the scope of the present disclosure.

FIG. 1 shows an exemplary system for managing transactions of members to a group account;

FIG. 2 is a block diagram of an exemplary computing device, suitable for use in the exemplary system of FIG. 1;

FIG. 3 is a block diagram of an exemplary method for managing transactions of members to a group account, which may be implemented in the exemplary system of FIG. 1;

FIG. 4 is an example interface displaying information related to transactions of a member to a group account, suitable for display on the computing device of FIG. 2 in connection with the system of FIG. 1 and/or the method of FIG. 3;

FIG. 5 is an example interface displaying information related to rewards redemption for the member associated with the group, suitable for display on the computing device of FIG. 2 in connection with the system of FIG. 1 and/or the method of FIG. 3;

FIG. 6 is another example interface displaying information related to transactions of a member to a group account, suitable for display on the computing device of FIG. 2 in connection with the system of FIG. 1 and/or the method of FIG. 3;

FIG. 7 is an example interface, for use by an administrator, displaying events and related details associated with a group, suitable for display on the computing device of FIG. 2 in connection with the system of FIG. 1 and/or the method of FIG. 3; and

FIG. 8 is an exemplary report, that can be generated in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Charitable organizations, fundraising organizations, and other organizations typically raise funds for the organizations through donations and/or sales of products, e.g., goods and/or services. The donations and sales of products may be funded through a variety of different payment forms. Example forms of payment may include cash and personal checks. In some circumstances, cash and/or personal check transactions may reduce overall donations and/or sales to members of the organizations, thereby reducing the funds to the organizations. The systems and methods described herein permit an organization to accept donations and/or sales of products, via payment networks, to payment accounts, and identify those transactions to particular members of the organization. The members are then able to view the performance of the organization relative to a goal, and/or individual member performance relative to one another (e.g., for encouraging gamification, etc.). The systems and methods herein further provide for analysis of the transactions to an organization, per member and/or event, and, in some instances, rewards associated with the performance of the member/event.

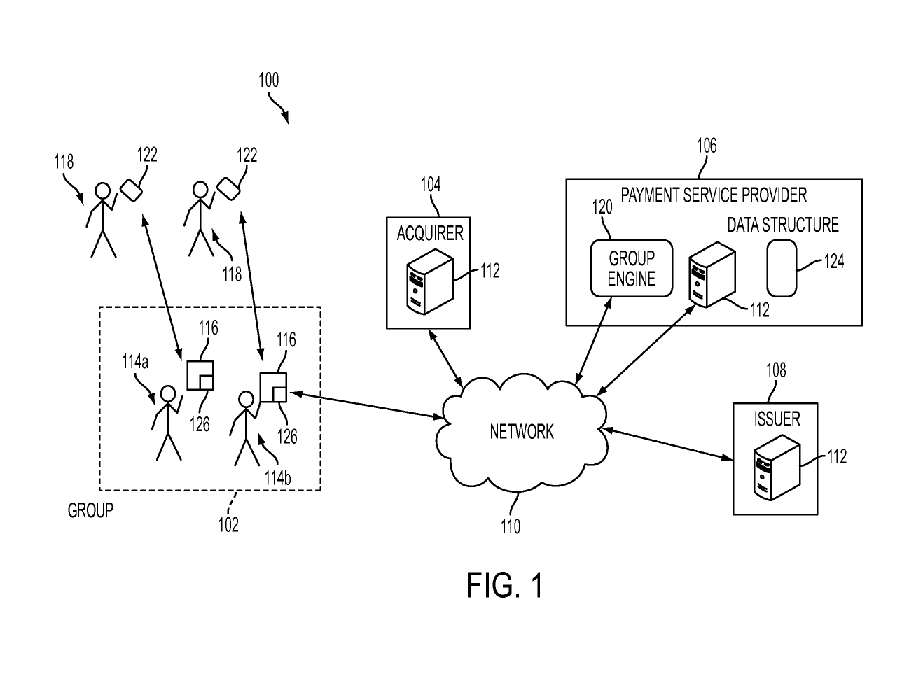

FIG. 1 illustrates an exemplary payment system 100, in which the one or more aspects of the present disclosure may be implemented. Although components of the system 100 are presented in one arrangement, other embodiments may include the same or different components arranged otherwise, depending, for example, on processing of payment account transactions, etc.

The illustrated system 100 generally includes a group 102, an acquirer 104, a payment service provider 106, and an issuer 108, each coupled to network 110. The network 110 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or even combinations thereof. In one example, network 110 includes multiple networks, where different ones of the multiple networks are accessible to different ones of the illustrated components in FIG. 1. In this embodiment, the acquirer 104, the payment service provider 106, and the issuer 108 each include a computing device 112 coupled to the network 110.

The group 102 may include a variety of different organizations, profit or non-profit, based on charity, service, religion, business, activity, product (or line of products), profession, or other commonality between members of the organizations (e.g., the Girl Scouts, Salvation Army, Little League® baseball/software, Avon® sales region, Tupperware® sales region, other organizations, etc.). The group 102 generally includes multiple members 114, as shown in FIG. 1. The group may also include multiple groups, with each of the multiple groups being an overall group and individual group within the broader group (e.g., troops, etc.), separated by geography, for example. The group 102, in this embodiment, relies on its members 114 to raise funds for an organization, through donations by consumers 118 and/or sales of products to consumers 118.

As shown in FIG. 1, each of the members 114 is associated with a computing device 116, which is connected to network 110 and referred to as a payment module. The payment modules 116 are used, by the members 114, to initiate payment transactions with consumers 118, which are funded by payment accounts associated with the consumers 118.

To initiate a transaction between one of the consumers 118 (e.g., purchasers, donors, customers, etc.) and one of the members 114, to raise funds for the group 102, the consumer 118 presents a payment device 122 associated with a payment account to the member 114. The payment device 122 may include, for example, a credit card, a debit card, a pre-paid card, a payment token, a payment tag, a pass, or another enabled device used to provide account information (e.g., a smartphone, a mobile application, a tablet, etc.) etc. In turn, the payment module 116 of the member 114 reads, scans, or otherwise receives payment account information from the payment device 122. The payment module 116 may receive the payment information from the payment device 122, via contact or non-contact, for example, by photo/image capture of the payment device 122, by swipe through a dongle input device of the payment module 116, by wireless radio-frequency (RF) broadcast (e.g., Bluetooth®, near field communication (NFC), etc.), by scan of a symbol, a barcode or a QR code, etc. Once the payment account information is received at the payment module 116, an authorization request is generated and transmitted to the acquirer 104. The authorization request, in this embodiment, includes a payment account number (PAN) for the consumer 118, an amount of the transaction, a member identifier for the particular member 114 involved in the transaction (e.g., member 114a or member 114b), product identifier(s), an event identifier, a group/member identifier for the group 102, and/or a group account number for the group 102, etc.

In this embodiment, each payment module 116 includes a transaction engine 126. The transaction engine 126 is configured, for example by computer-readable instructions, to display one of multiple products for purchase (along with price, description, etc.) at a purchase interface to the member 114 and/or the consumer 118 (via one or more output devices), and accept inputs to purchase one or more of the products (via one or more input devices). The transaction engine 126 is further configured to cause the payment module 116 to read payment information from payment device 122 (via one or more input devices), and to compile and transmit the authorization request (described above) to the acquirer 104. The transaction engine 126 may further include a variety of additional features related to transactions to the group account of the group 102, including for example, interacting with a group engine 120 associated with the payment service provider 106, to display interface(s) at the payment module 116, for example.

In response to the authorization request, the acquirer 104, the payment service provider 106, and the issuer 108 cooperate to authorize and/or clear the transaction. In particular, the acquirer 104 communicates with the issuer 108, through the payment service provider 106, for authorization for the transaction. If the issuer 108 accepts the transaction, an authorization response is provided back through the payment service provider 106 (and the associated payment network) to the payment module 116, at the member 114, which permits the member 114 to complete and/or confirm the transaction with the consumer 118. The credit of the consumer 118 is altered by the amount of the transaction, and the charge/credit is posted to the account of the group 102 associated with the payment module 116. The transaction is later cleared by and between the acquirer 104 and the issuer 108, directly or via the payment service provider 106. Debit and pre-paid payment account transactions are substantially similar to the above, but, in some embodiments, may further include the use of a personal identification number (PIN) authorization and more rapid posting of the charge/credit to the account associated with the device 122, etc. In various embodiments, depending on the payment account, upon authorization or clearing, loyalty points and/or rewards, specific to the merchant 114 or payment account, are also assigned to the payment accounts or customers 118, based on the transactions (e.g., discounts on future purchases, free items at the merchant 114, deals such as buy 5 items and get 20% off, etc.).

Because the transaction, in this embodiment, is directed/credited to a group account, the funds for the transaction are provided directly to the group 102, preferably without interaction by the individual members 114. In this manner, funds are more readily available to the group 102, and intermediate handling of payments by the members 114 may be omitted, or reduced.

Transaction data is generated as part of the above interactions among the group 102, the acquirer 104, the payment service provider 106, the issuer 108, the member 114, and the consumer 118. The transaction data may include, without limitation, the PAN for the consumer's payment account, the amount for the transaction, identifier(s) for the product(s) purchased, description(s) of the product(s) purchased, a listing of products purchased in the transaction, a member identifier, a group identifier, the group account number, a merchant category code (MCC), a geographic indicator, a date and/or time of the transaction, etc. The transaction data is transmitted from the member 114 (and/or the group 102), depending on the transaction, to the issuer 108 through the payment service provider 106 (and broadly, the payment network). The transaction data may be stored at different entities participating in the transactions, along the payment network. In this embodiment, the transaction data is stored in a data structure 124 of the payment service provider 106, which may be incorporated in or separate from the computing device 112 of the payment service provider 106. In this and other embodiments, the transaction data may be stored as separate data related to or identified to the group 102, or the member 114, and/or may be stored in combination with a variety of other transaction data.

With continued reference to the exemplary system of FIG. 1, the payment service provider 106 includes the group engine 120. While the group engine 120 is illustrated as part of the payment service provider 106 in this embodiment, the group engine 120 may be separate from the payment service provider 106 in other embodiments. In various embodiments, the group engine 120 may be coupled to, or otherwise interact with the payment service provider 106, and in particular, the data structure 124 of the payment service provider including the transaction data for the group 102, via network 110 or other suitable connections. Moreover, it should be appreciated that while the group engine 120 is included and/or associated with the payment service provider 106 in the illustrated embodiment, a group engine as described herein may be included and/or associated with other entities, including, for example, the acquirer 104 or issuer 108 or other entities, in other embodiments.

Further, the group engine 120 may be incorporated into the computing device 112 of the payment service provider 106, or may be a separate computing device located together with and/or distributed apart from the computing device 112.

In the embodiment of FIG. 1, the computing devices 112 and 116 may include a single computing device, or multiple computing devices located together and/or distributed across a geographic region. Each computing device may include, without limitation, a server, a desktop computer, a laptop computer, a workstation computer, a personal computer, a tablet computer (e.g., an iPad™, a Samsung Galaxy™, etc.), a handheld computer or other communication device, a smart phone (e.g., an iPhone™, a BlackBerry™, etc.), the like, or combinations thereof.

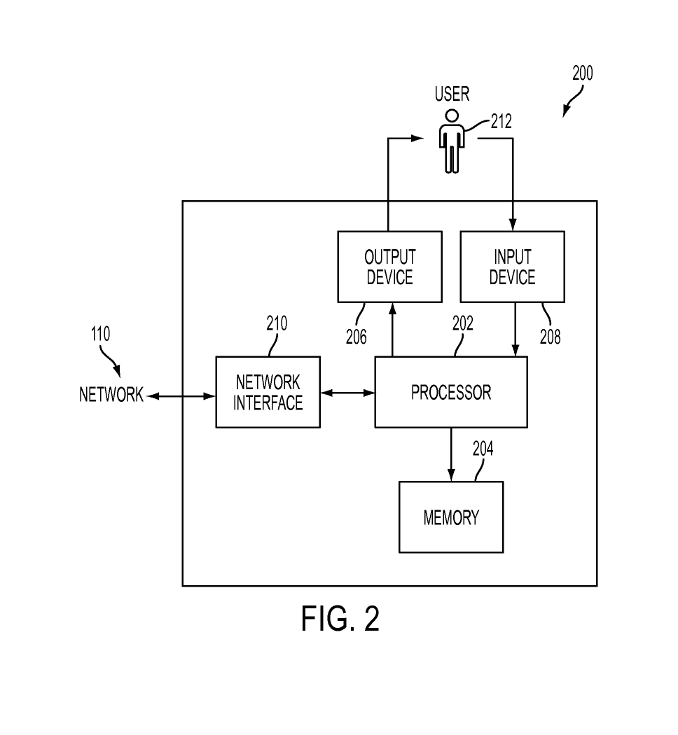

FIG. 2 illustrates an exemplary computing device 200. For purposes of the description herein, each of the computing devices 112 and 116 shown in FIG. 1 is a computing device, consistent with computing device 200. It should be appreciated that the computing devices 112, 116 of FIG. 1 should not be understood to be limited to the arrangement of the computing device 200, as depicted in FIG. 2. Different components and/or arrangements of components may be used in other computing devices. In various embodiments, the computing device 200 includes multiple computing devices located in close proximity, or distributed over a geographic region.

The exemplary computing device 200 includes a memory 204 and a processor 202 that is coupled to memory 204. Processor 202 may include one or more processing units (e.g., in a multi-core configuration, etc.). Computing device 200 is programmable to perform one or more operations described herein by programming the memory 204 and/or processor 202. Processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

Memory 204, as described herein, is one or more devices that enable information, such as executable instructions and/or other data, to be stored and retrieved. Memory 204 may include one or more computer-readable media, such as, without limitation, dynamic random access memory (DRAM), static random access memory (SRAM), a solid state disk, and/or a hard disk. Memory 204 may be configured to store, without limitation, transaction data, group account information, one or more data structures as described herein, member identifiers, group identifiers, reward points for members, goals associated with the members/groups, etc.

The computing device 200 also includes an output device 206 and an input device 208 coupled to the processor 202.

The output device 206 of the computing device 200 outputs information and/or data to a user 212 (e.g., member 114, consumer 118, etc.) by, for example, displaying, audibilizing, and/or otherwise outputting the information and/or data. In some embodiments, the output device 206 may comprise a display device such that various interfaces (e.g., webpages, applications interfaces, etc.) may be displayed at computing device 200, and in particular at the display device, to display such information and/or data, etc. And in some examples, the computing device 200 may cause the interfaces to be displayed at a display device of another computing device, including, for example, a server hosting a website having multiple webpages, etc. With that said, the output device 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device 206 may include multiple devices.

The input device 208 of the computing device 200 is configured to receive input from a user 212. The input device 208 may include, without limitation, a keyboard, a pointing device, a mouse, a stylus, a RF receiver, a card-swipe dongle, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both an output device and an input device.

In the exemplary embodiment, computing device 200 also includes one or more network interface devices 210 coupled to processor 202. Network interface device 210 may include, without limitation, a wired network adapter, a wireless network adapter, a mobile telecommunications adapter, or other device capable of communicating to one or more different networks, including the network 110. In at least one embodiment, computing device 200 includes processor 202 and one or more network interface devices 210 incorporated into or with processor 202.

In further embodiments, computer-executable instructions are stored on non-transitory memory 204 for execution by processor 202 to perform one or more of the functions described herein. These instructions may be embodied in a variety of different physical or tangible computer-readable media, such as memory 204 or other non-transitory memory, such as, without limitation, a flash drive, CD-ROM, thumb drive, floppy disk, etc.

Referring again to FIG. 1, the group engine 120 is configured to, among other things (and in addition to the functions previously described), access transaction data identified to the group 102 and/or the members 114 of the group, aggregate the transactions to the identified group 102 and/or the members 114, etc. For example, when a member 114 initiates a transaction with a consumer 118 (either a donation or a purchase, for example), the group engine 120 may cause the transaction data, representing the transaction to the group account, when received by the payment service provider 106 via the network, to be stored in the data structure 124. The group engine 120 may then provide one or more interfaces, to be displayed at one or more of the computing devices 200, such that members 114, administrators (not shown), and/or others, etc., may access information related to the transactions to the group account. The group engine 120 may further be configured to cause one or more interfaces to be displayed at the one or more of the computing devices 200, which include reward point totals, reward products, and/or reports related to the transactions to the group account of the group 102, and further receive inputs from the members 114 and/or administrator(s) via the interfaces.

The one or more interfaces may permit members 114 to view gamification information, redeem rewards, access data analytics information, etc. Gamification information, as referred to herein, may include any information associated with providing one or more gaming related elements to the transactions among the members 114 of the group 102, to the events of the group 102, or among different groups. For example, gamification may include providing indicators (e.g., symbols, medals, badges, etc.) when a member 114 reaches one or more thresholds of transactions (e.g., a predefined number of transactions, a predefined dollar amount of transactions, etc.), often providing member/group goals and indicators of progress toward the member/group goals and comparisons between member/group transaction performances, etc. In connection therewith, the member 114 is able to view his/her standing with respect to other members, with respect to the local group, with respect to a whole group, with respect to the organization, etc.

The group engine 120 is further configured to allow administrators to view analytics data related to the transactions of the members 114 and/or the group 102 (and/or to other groups and their members, where organizations include such multiple groups). For example, administrators may be able to view performance reports for the group 102 and/or for the members 114 of the group 102 to understand relative performance of the group 102 and/or the members 114. Such information may then be used to inform future goal setting, fundraising events, etc. Administrators may also be able to view geographic location information to determine which areas are generating the certain thresholds of transactions, to inform future member distributions, routes, etc., and thereby potentially improve the fundraising results of the members 114 and the group 102.

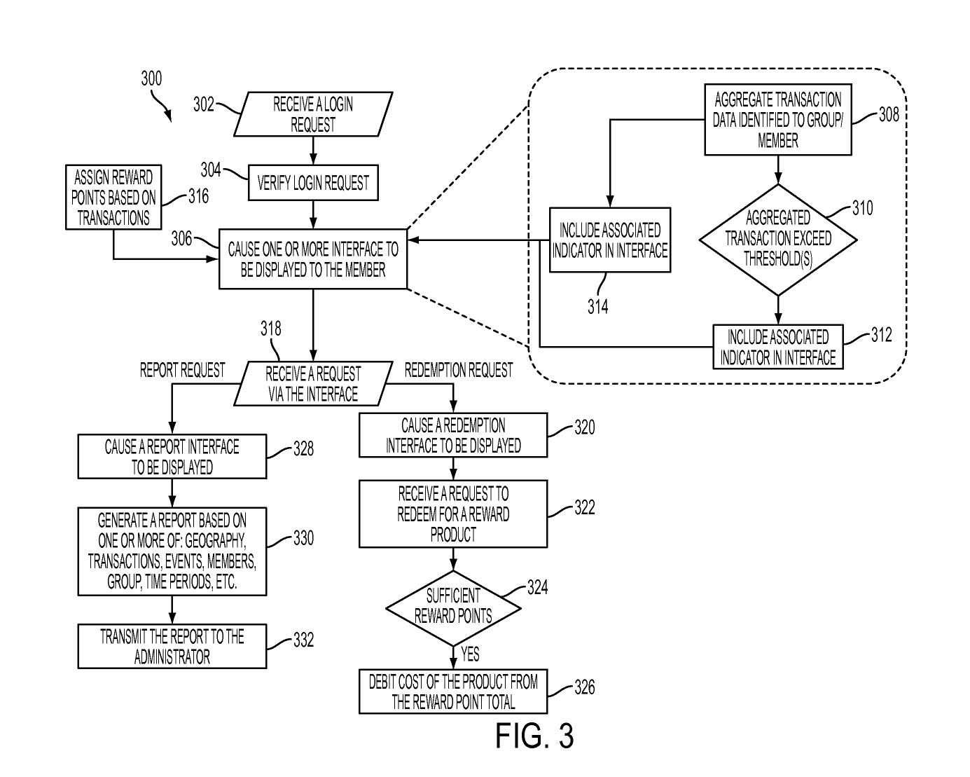

FIG. 3 illustrates an exemplary method 300 for use in managing payment network transactions to a group account. The method 300 is described with reference to the system 100, and computing device 200. It should be appreciated, however, that methods herein should not be understood to be limited to the exemplary system 100, or the computing device 200, but may be implemented in a variety of different systems and/or computing devices. Likewise, the systems and computing devices herein should not be understood to be limited to the method 300.

Referring to FIG. 3, the group engine 120 receives a login request from a member 114, at 302. To initiate the login request, the member 114 enters a username, password, token or other credential(s) to an interface displayed at a computing device associated with the member 114, such as, for example, the payment module 116. The credentials may be unique to the member 114, or the same for multiple of the members 114, or even generic to the group 102. The type and uniqueness of the credentials may be selected based on the access to be permitted to the interfaces discussed below. For example, the login may be private to the member 114, thereby permitting the member 114 access to the certain interfaces (as described below), while restricting the access of others. The login credentials may further be semi-private, such that multiple members 114, administrators, or others are permitted access, while others are not. In at least one example, login credentials are non-private, or public. Additionally, or alternatively, certain interfaces may be viewable by members or others with or without login requests. For example, one or more interfaces may be viewable by friends and/or family of a member 114, without presenting a login request. In such an example, the friends and/or family are able to view the status of the member 114, or the group 102, to provide further incentive to the member 114 to initiate transactions and/or to permit friends and/or family to seek out the member 114 to aid in accomplishing one or more goals/metrics.

As should be appreciated, a variety of different login rules/criteria may be employed to permit or limit access to the group 102 and its transactions, potentially based on, for example, the type of the group 102, the types of events organized by the group 102, the types of transactions, a relationship to the group 102, etc.

Upon receiving the login request, the group engine 120 verifies the request, at 304. The verification may include searching for the received login credentials in a data structure of reference login credentials, for example, in data structure 124, in another data structure, or otherwise. Upon finding a match, the group engine 120 verifies the login request. It should be appreciated that the group engine 120 may employ further, or different, approaches to verifying login requests from the member 114, administrators, or others.

After verifying the login request for the member 114, the group engine 120 causes, at 306, one or more interface to be displayed to the member 114, at a computing device associated with the member 114 (e.g., the payment module 116, another computing device 200, etc.). In one example, in response to the member's login request, the group engine 120 causes a particular member interface to be displayed to the member 114. The member interface may include a variety of different indicators indicative of transactions identified to the member 114, transactions identified to other members 114, and/or transactions identified to the group 102. In this manner, the member 114 of the group 102 (as well as other members 114 of the group, following similar login verifications) are able to view his/her relative performance, and receive badges, symbols, or other indicators representative of performance in raising funds for the group 102. The members 114 of the group 102 thus may be encouraged to initiate additional transactions, for example, to gain more or different indicators, or compete against other members 114 of the group 102 or against other groups, etc. (e.g., via gamification, etc.).

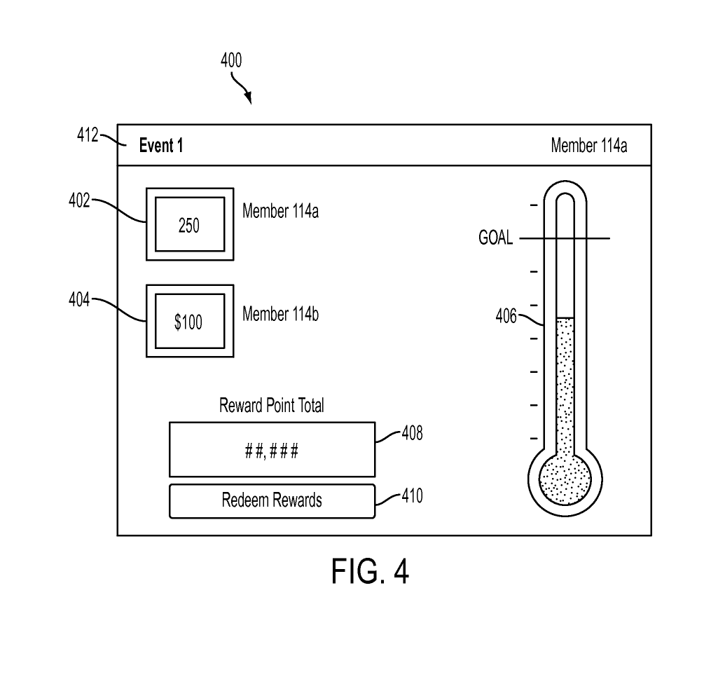

FIG. 4 illustrates an example member interface 400 that may be displayed to member 114a, upon verification of his/her login request. The member interface 400 includes an indicator 402 associated with the member 114a and an indicator 404 associated with member 114b. The indicators 402, 404 may include any different symbol, graphic, badge, etc., but will be representative of transactions identified to the particular members 114a, 114b. Specifically, in FIG. 4, the indicator 402 is depicted as a badge embossed with “250,” which, in this example, is indicative of 250 products sold by the member 114a. Further, in FIG. 4, the indicator 404 is depicted as a badge embossed with “$100,” which, in this example, is indicative of $100 in sales and/or donations identified to the member 114b. As such, the member 114a, by viewing the interface 400, is informed of the transactions identified not only to him/her but also those identified to the second member 114b. A similar interface may also be available to the member 114b, in response to a login request, and/or to other members 114 of the group 102.

It should be appreciated that any different type of indictor(s) may be included in a member interface in other embodiments.

Referring again to FIG. 3, indicators may be included in the one or more interface based on one or more predefined thresholds, or otherwise. For example, as part of causing one or more interface (e.g., the member interface, etc.) to be displayed, at 306, the group engine 120 aggregates, at 308, the transactions identified to the members 114, the transactions identified to the group 102, or otherwise, to determined which, if any, indicators to include in the one or more interface. The group engine 120 then determines, at 310, if the aggregated transactions exceed one or more thresholds, which are associated with the indicators. Based on the determination, the appropriate indicators are included in the interface, at 312.

It should be appreciated that a number of different thresholds (e.g., member thresholds, event thresholds, group thresholds, etc.) may be used relative to aggregated transactions identified to members 114, individually, or to aggregated transactions identified to particular events or to the group 102, and/or combinations thereof, which may be exceeded (or not exceeded) (broadly, when the thresholds are satisfied) whereby the group engine 120 then includes one or more indicators in the interface. For example, badges may be included and displayed when a member 114 reaches certain threshold sales amounts, such as $100, $500, $1000, etc., or certain threshold quantity amounts, such as 100, 500, 1000, or 100,000 products, etc. Other indicators may further be included and displayed, for example, for the highest dollar transactions, highest quantity transactions, etc., within the group 102 or for multiple transactions, such as, for example, most transactions in a predefined interval (e.g., week, month, or duration of the event, etc.), etc. The thresholds are generally predefined by the administrator of the group 102 (or organization), per group, member, and/or event (at set-up or later), or by others.

In addition, the group engine 120 may decide, based on most recent transactions, or rules provided by the members 114 and/or the group 102, for which members 114 to include indicators. In particular, where a group includes a large number of members, it may be undesirable to include an indicator for each member, or multiple indicators for each member in an interface. For example, the group engine 120 may decide to display an indicator to a member for a particular period of time, such as 24 hours, 1 week, etc., or until new indicators are assigned to other members at a later time, or until another indicator is assigned to the member, or until various other factors are satisfied, etc.

In the example member interface illustrated in FIG. 4, the group engine 120 aggregates the transactions identified to the member 114a and the transactions identified to the member 114b. For member 114a, the aggregated transactions are 261 in total products. The 261 total amount exceeds a 250 threshold, but does not exceed a 275 threshold. Accordingly, based on the aggregated transactions and the 250 threshold, the group engine 120 includes the 250 indicator 402 in the member interface 400 (but not the 275 indicator). Similarly, for member 114b, the aggregated transactions are $103.80. The $103.80 amount in aggregated transactions exceeds a $100 threshold, but does not exceed a $125 threshold. Accordingly, based on the aggregated transactions and the $100 member threshold, the group engine 120 includes the $100 indicator 404 in the member interface 400 (but not the $125 indicator).

With reference again to FIG. 3, in another aspect of the method 300, the group engine 120 may also include indicators for the group 102, as a whole. For example, at 308, the group engine 120 may also (or alternatively) aggregate transactions identified to the group 102, which includes the transactions identified to each of the members 114 of the group 102. The group engine 120 then further includes, at 314, an indicator in the interface based on the aggregated transactions of the group 102. The group indicator may be in value or quantity, and may include a goal or threshold (e.g., a status indicator, etc.), or not. The indicator may also be a graphic, symbol, badge, or other indicator indicative of the aggregated transactions of the group 102, alone or relative to one or more thresholds. In at least one embodiment, members 114 may be permitted to form teams within the group 102, and the group engine 120, like with the member 114a or the group 102, may then include indicators associated with the transactions identified to the teams, as appropriate.

In the example member interface 400 illustrated in FIG. 4, indicator 406 is based on aggregated transactions to the group 102. The indicator 406 includes a thermometer, with a portion of the thermometer shaded and the goal of the group 102 indicated. The indicator 406, for example, permits the member 114a, and potentially others, to view a general status of the group 102 relative to one or more goals of the group 102.

Also in the interface 400, relative positioning of the indicators 402, 404, 406 (or other indicators) in the interface 400 (or in other interfaces) may further be indicative of performance (or relative performance) of the members 114a, 114b and/or group 102. For example, the indicator 402 is positioned above the indicator 404 in the member interface 400, indicating that the indicator 402 was more recently earned, or that the indicator 402 is the top performance in the last day, week, etc. Similarly, while not shown, the group indicator 406 may be compared to corresponding indicators of other groups, etc. More generally, the position of the indicators 402, 404, 406 within the interface 400 may indicate or constitute a relative comparison of the transactions identified to the member 114a and the transactions identified to the member 114b.

In some embodiments, member interfaces (or other interfaces) may further include a status relative to one or more of the indicators included in the interfaces. The status may identify additional transactions required (e.g., value of transactions, amount of transactions, etc.) to satisfy subsequent thresholds and obtain additional indicators. For example, in the interface 400, a status indicator may be included for member 114a, indicating he/she is $21.20 in sales away from the $125 indicator. In this manner, the member 114a is able to view his/her own status relative to one or more of the various thresholds, and gain an understanding that certain additional transactions may result in a subsequent indicator and may even cause his/her subsequent indicator to be included in other members interfaces. It should be appreciated that the indicators, and their relative status related to various thresholds, may be altered in any manner, based on, for example, the members 114 or the group 102, to encourage increased fundraising/sales competition among the group 102.

Referring back to FIG. 3, the group engine 120 further assigns reward points, at 316, to a reward account associated with the member 114 based on transactions identified to the member 114. The group engine 120 includes the reward points, as part of a reward point total for the member 114, in one or more interface. It should be appreciated that the group engine 120 may assign reward points to the members 114 according to any number of different rules and/or conversations between transaction quantities/values and reward points, etc. The group engine 120 is further configured to receive redemption requests from the member 114, at 318, to redeem the reward points in his/her reward account. When the group engine 120 receives the request, the group engine 120 causes, at 320, a redemption interface to be displayed at the computing device 200 associated with the member 114.

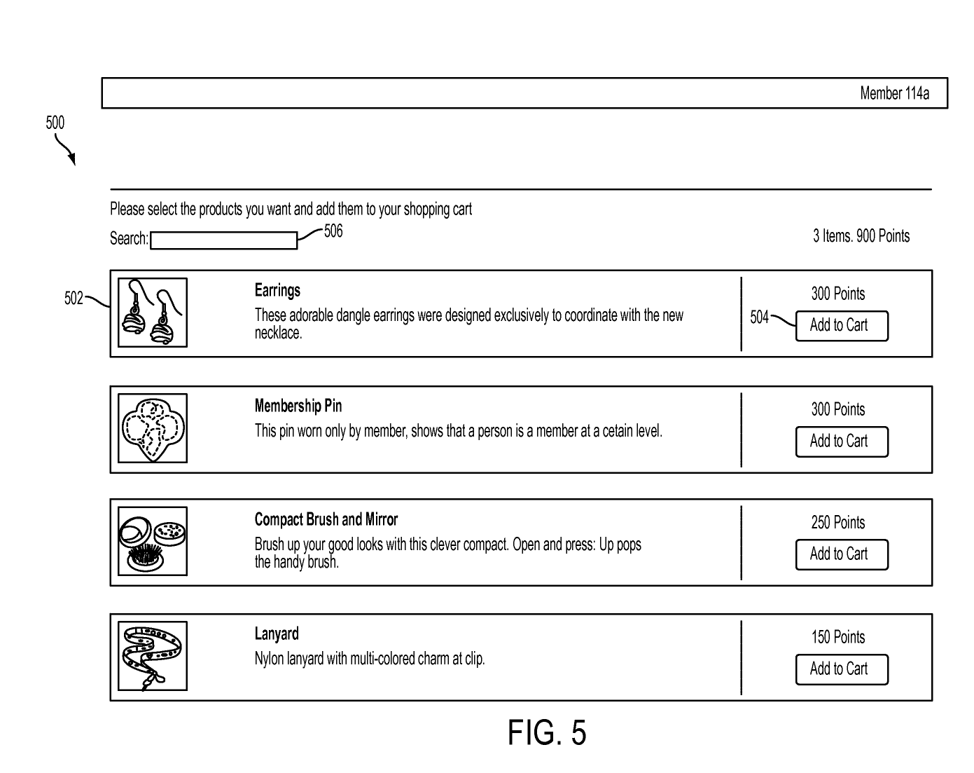

As shown in FIG. 4, the example member interface 400 includes a reward point total 408, which is indicative of the reward points assigned to the member 114a. The interface 400 also includes a redemption request option 410, which may be actuated by the member 114a, to redeem the reward points. FIG. 5 illustrates an exemplary redemption interface 500 that may be presented to the member 114a upon selection of the redemption request option 410 in interface 400. As shown, the interface 500 includes multiple reward products 502, each associated with a title, a brief description, and a cost, for example. The example interface 500 further includes a search box 506, which permits the member 114a to search for specific reward products. The interface 500 further includes a redemption button 504 associated with each reward product, to enable the member 114a to select one or more of the reward products 502.

With reference again to FIG. 3, upon selection of a reward product (to purchase), and a request to purchase the product, from the member 114, a reward product request is received at the group engine 120, at 322. The group engine 120 then determines, at 324, whether the reward account of the member 114 has sufficient reward points to fund the purchase of the reward product. If sufficient reward points are available, the group engine 120 processes the transaction (e.g., transmits instructions/funds to a vendor of the reward product, etc.) and debits the cost of the reward product, at 326, from the reward point total, at the reward account of the member 114. Once the reward point cost of the product is deducted, the group engine 120 updates the reward point total (e.g., reward point total 408 in the interface 400, etc.). It should be appreciated that a variety of different interfaces may be displayed at member computing devices 200 (e.g., at payment modules 116, etc.) to permit the members 114 to purchase reward products using reward points.

In at least one embodiment, one or more interfaces (e.g., interfaces 400, 500, etc.; other interfaces; etc.) may include an explanation and/or listing of rules by which reward points are assigned to the members 114 of the group 102. Each of the members 114 may then, in some examples, review the rules and adjust his/her transaction efforts to seek additional reward points, as compared to prior transaction efforts.

As further shown in FIG. 4, the example interface 400 is specific to “Event 1” as indicated at 412. As such, the group 102 and/or member 114a, in this example, is/are limited to the one event, for which the indicators 402, 404, and 406 are indicative of transactions identified to the member 114a and the group 102.

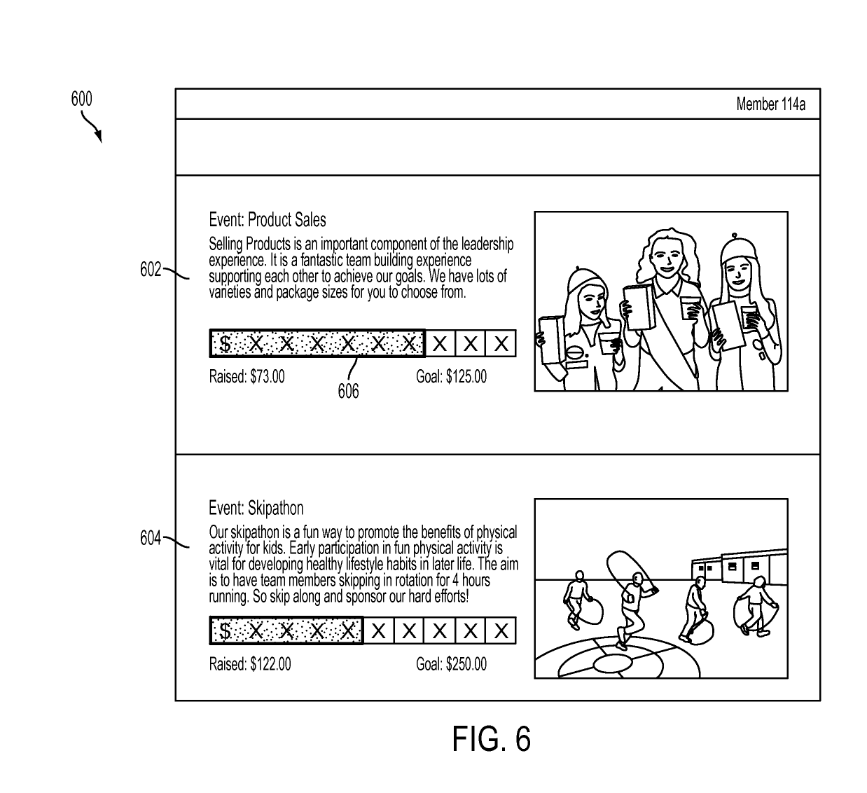

Alternatively, if the group 102 and/or the member 114a are involved in multiple events, group interface 600, illustrated in FIG. 6, may instead be displayed at the computing device 200, upon login, or after login, etc. Accordingly, when the member 114a provides a login request to the group engine 120, in this alternative, the group interface 600 is displayed at the computing device 200 associated with the member 114a (rather than interface 400).

Group interface 600 illustrates multiple fundraising events associated with the group 102. In particular, the group 102 is associated with and/or coordinating two events: a product sale event 602 and a skipathon event 604. The group interface 600 also includes information about the events and/or a status of the group 102 and/or the member 114a in the events. As shown, for each event, a title and a brief description of the event is provided, along with a status indicator 606 of transactions identified to that event, relative to a goal for the event. When the member 114a selects one of the events 602, 604, the group engine 120 receives that selection and then causes the interface 400 to be displayed at the computing device 200 of the member 114a, with information included therein specific to the selected event. As should be appreciated, any different information and/or indicator about the events 602, 604, the group 102, or the member 114a may be included in the group interface 600. In at least one embodiment, the member's status relative to a goal, or a ranking of the member 114a relative to other members of the group 102 may be included. In addition, and while not shown in FIG. 6, the group interface 600 may further include the reward point total for member 114a and the option to redeem reward points. With that said, it should be appreciated that the number and/or type of events for groups and/or members may vary in other embodiments.

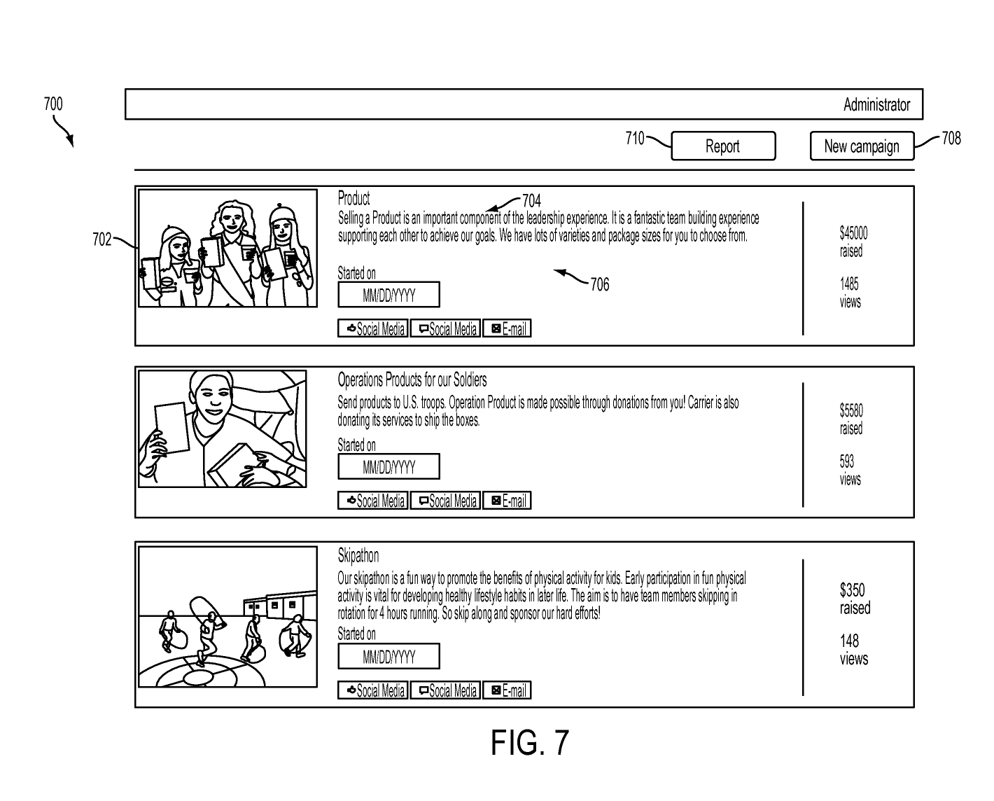

Referring back to FIG. 3 again, the group engine 120 responds to a login request at 302 as previously described. The above description is generally related to login by a member 114. In addition in the method 300, the group engine 120 may receive and accept an administrator login at 302. Upon verifying the administrator login request at 304, the group engine 120 causes an administrator interface to be displayed, at 306, at a computing device associated with the administrator. An example administrator interface 700 is illustrated in FIG. 7. Similar to interface 600, the administrator interface 700 includes the different events 702 of the group 102. Each event 702, in the illustrated embodiment, includes a title 704 and a description 706 of the activities/purpose of the event 702, a total amount of funds raised, a number of views, buttons for sharing information about the event 702, and/or a photo related to the event 702, etc. The interface 700 further includes a “New Campaign” button 708 for setting up and/or coordinating a new event.

Next, in connection with the administrator login, the group engine 120 may receive a report request, at 318, from the administrator (e.g., via the administrator interface 700, etc.). In response, the group engine 120 causes a report interface (not shown) to be displayed at the computing device associated with the administrator, at 328. From the report interface, the administrator may generate one or more different types of analytics reports, based on any number of different parameters, and/or standard reporting formats or member-specific, group-specific, or event-specific forms, etc. In at least one embodiment, the report interface includes predefined reporting graphics, indicative of different performance characteristics of the group 102 and/or members 114. The predefined graphics, in such an embodiment, may be automatically displayed to the administrator with the report interface upon selecting a reporting button, without separately entering the parameters of the report. For example, as shown in FIG. 7, the exemplary administrator interface 700 includes a reporting button 710, which permits the administrator to generate one or more reports related to one or more of the events 702, the group 102, the member 114a, other ones of the members 114, etc.

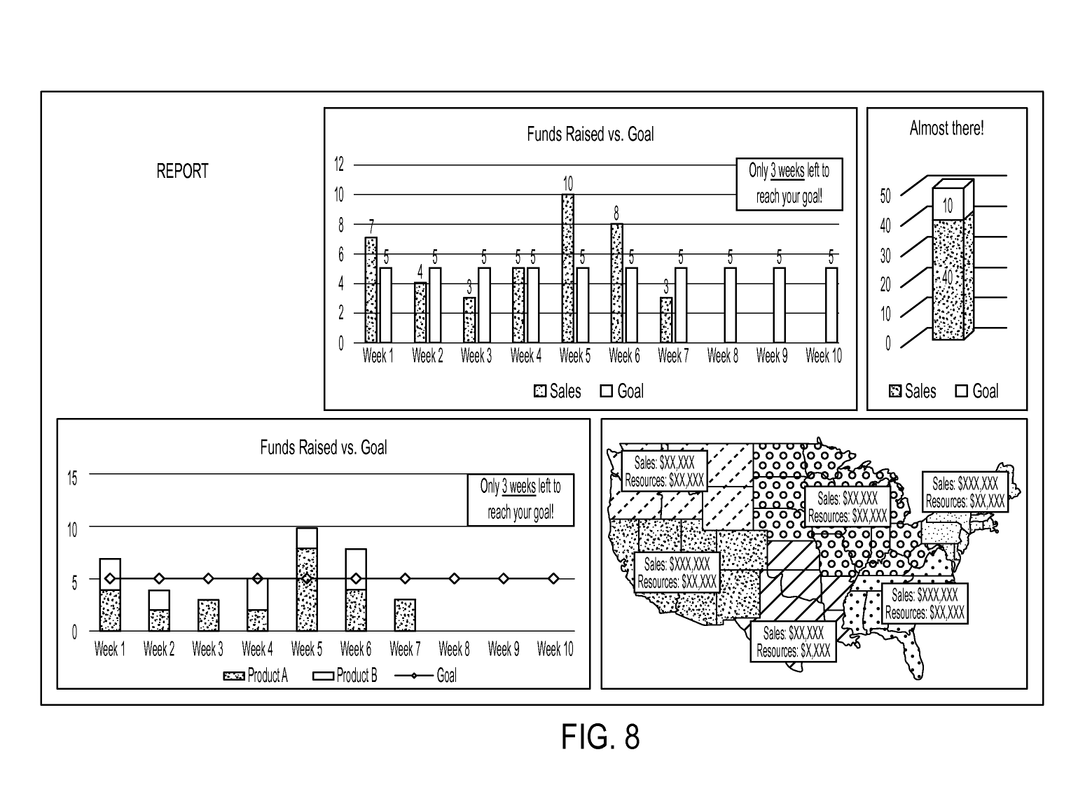

Example parameters for the one or more reports may include, without limitation, time periods (e.g., long term, the last month, the last week, etc.), geographic indicators, members, groups, events, geographic locations, transaction thresholds, payment product types (e.g., credit, debit, prepaid, etc.), goal/target (individual or group), sales of the campaign, hardware, time left in campaign, point of sale (POS) device type and/or versions, etc. Based on the one or more parameters, the group engine 120 generates a report, at 330. Generally, the reporting of transactions may assist the member 114, administrator, or others to determine which geographic locations (e.g. based on geographic indicators for transactions, etc.) are the most successful for fundraising, to determine efficient distribution routes for purchased goods, to determine future sales campaigns, activities and goals, to simplify accounting practices, to gain insights into the consumer(s) 118, etc. Analytics included in the report interface may display optimal sales regions based on long term and recent historical global network trends. Administrators may be able to review which members/groups are doing optimally, better or worse than others, and choose to alter the indicators, rewards points per transaction or other aspect of the member/group interaction to further encourage increased fundraising/sales competition. One example report is illustrated in FIG. 8.

At 332, the group engine 120 transmits the report to the administrator. Transmitting the report may include, for example, causing the report to be displayed at the computing device associated with the administrator, or sending the report in a format, which is savable or viewable by the administrator, via the network 110.

In at least one embodiment, a report is generated and transmitted to the member 114. The report may be generated based on a request, to the group engine 120, from the member 114, and administrator, or others.

As can be seen, the systems and methods herein provide various advantages in connection with managing transactions to a group account of an organization. Some example embodiments may provide less cash dependence for facilitating transactions, faster and more accurate processing of fundraising, better coordination of location-based marketing and transportation routing, increased spending/donating at the time of purchase/sale, increased safety for members carrying less cash, etc.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data associated with a group account, the transactions data representing multiple transactions, each of the transactions directed to a payment account of a customer and identified to one of the members; (b) generating a member interface including a first indicator associated with the transactions identified to the first member and a second indicator associated with transactions identified to the second member, wherein the member interface identifies the second indicator to the second member; (c) causing the member interface to be displayed at a computing device associated with the first member; (d) aggregating the transactions identified to the second member; (e) defining the second indicator based on the aggregated transactions identified to the first member; (f) aggregating the transaction identified to the group account; (g) defining a third indicator in the member interface based on the aggregated transactions identified to the group; (h) causing a redemption interface to be displayed at the computing device associated with the first member, the redemption interface including at least one product; (i) receiving a reward request for the at least one product; and (j) debiting a reward point total for the first member based on a cost associated with the at least one product.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

What is claimed is:

1. A system for managing transactions to a group account processed through a payment network, the group account associated with a group having multiple members, the multiple members including at least a first member and a second member, the system comprising:
a memory including a data structure, the data structure including transaction data representing multiple payment network transactions to the group account, each of the multiple transactions identified, in the transaction data, to one of the multiple members;
a processor coupled to the memory and configured to:
receive a login request from the first member;
verify the login request from the first member; and
after verifying the login request, cause a member interface to be displayed at a computing device associated with the first member, the member interface including a first indicator associated with the first member and representative of transactions identified to the first member, the member interface including a second indicator associated with the second member and representative of transactions identified to the second member;
whereby the member interface informs the first member of the second member and the transactions identified to the second member.

2. The system of claim 1, wherein the processor is configured to:
aggregate the transactions identified to the second member; and
include the second indicator in the member interface based on the aggregated transactions identified to the second member and at least one member threshold, wherein the second indicator is indicative that the at least one member threshold has been satisfied.

3. The system of claim 2, wherein the processor is further configured to:
aggregate the transactions, for a predefined interval, to the group account;
include a third indicator in a group interface based on the aggregated transactions to the group account; and cause the group interface to be displayed at the computing device associated with the first member.

4. The system of claim 1, wherein the processor is further configured to assign one or more reward points to a reward account associated with the first member based on at least the transactions identified to the first member; and
wherein the member interface includes the reward points for the first member.

5. The system of claim 4, wherein the processor is further configured to:
cause a redemption interface to be displayed at the computing device associated with the first member, the redemption interface including products offered for sale and a reward point cost associated with each of the products;
receive from the first member, via the computing device, a request to purchase at least one of the products; and
debit the cost of the at least one of the products from the reward account associated with the first member, when the reward points in the reward account exceed the cost of the at least one of the products.

6. The system of claim 1, wherein the processor is further configured to generate a report for the group, the report indicative of at least the transactions to the group account, and separately, the transactions identified to the first and second members.

7. The system of claim 1, wherein the processor is further configured to:
receive an admin login request from an administrator;
verify the admin login request; and
after verifying the admin login request, cause an admin interface to be displayed at a computing device associated with the administrator, the admin interface including at least a third indicator based on the transactions to the group account and at least one predefined group threshold.

8. The system of claim 1, wherein the member interface is specific to an event associated with the group.

9. The system of claim 1, wherein the processor is configured to include the first indicator and the second indicator at a position within the member interface based on a relative comparison of the transactions identified to the first member and the transactions identified to the second member.

10. The system of claim 1, further comprising the computing device associated with the first member; and
wherein the computing device associated with the first member includes a transaction engine comprising instructions that, when executed by the computing device, cause the computing device to read a payment device and transmit an authorization request to the payment network including transaction data for one or more transactions involving the payment device, the transaction data including a payment account associated with the payment device, a number associated with the group account, and an identifier of the first member.

11. The system of claim 10, wherein the instructions, when executed by the computing device, cause the computing device to display a purchase interface including multiple products for sale; and
wherein the computing device is configured to capture an image of the payment device, in order to read the payment device.

12. The system of claim 1, wherein each of the multiple transactions is associated with a geographic indicator included in the transaction data; and
wherein the processor is further configured to generate a report for the group, based on, at least in part, the geographic indicator of the multiple transactions.

13. A method for managing payment network transactions to a group account associated with a group having multiple members, the multiple members including at least a first member and a second member, the method comprising:
accessing, by a computing device, transaction data associated with a group account, the transaction data representing multiple transactions to the group account, each of the transactions directed to a payment account of a customer and identified to one of the multiple members of the group;
generating, by the computing device, a member interface including a first indicator associated with transactions identified to the first member of the group and a second indicator associated with transactions identified to the second member of the group, wherein the member interface identifies the second indicator to the first member; and
causing, by the computing device, the member interface to be displayed at a computing device associated with the first member.

14. The method of claim 13, wherein generating the member interface includes:
aggregating the transactions identified to the second member;
defining the second indicator based on the aggregated transactions identified to the second member;
aggregating the transactions identified to the group account; and
defining a third indicator in the member interface based on the aggregated transactions identified to the group account.

15. The method of claim 13, further comprising:
causing a redemption interface to be displayed at the computing device associated with the first member, the redemption interface including at least one product;
receiving a reward request for the at least one product; and
debiting a reward point total for the first member based on a cost associated with the at least one product.

16. A non-transitory computer readable media comprising computer-executable instructions which, when executed by at least one processor, cause the at least one processor to:
aggregate one or more of multiple payment network transactions to a group account associated with a group, based on at least one member of the group identified to the one or more multiple transactions;
cause a member interface to be displayed at a computing device, in response to a request from a member of the group, the member interface including, for each of at least two members of the group, an indicator associated with aggregated transactions for each of said at least two members; and
cause a group interface to be displayed at a computing device, in response to a request from a member, the group interface including a group indicator based on aggregated transactions to the group account.

17. The non-transitory computer readable media of claim 16, wherein the member interface includes a reward point total and an option to redeem reward points.

18. The non-transitory computer readable media of claim 17, wherein the computer-executable instructions, when executed by the at least one processor, further cause the at least one processor to:
receive a login request from one of a member and an administrator; and
verify the login request, prior to causing the group interface to be displayed.

19. The non-transitory computer readable media of claim 16, wherein each indicator includes a graphic indicative of a threshold exceeded by the aggregated transactions.

20. The non-transitory computer readable media of claim 16, wherein the computer-executable instructions, when executed by the at least one processor, further cause the at least one processor to generate a report for the group, the report including geographic indicators for at least some of the multiple transactions.
